(19) United States
(12) Patent Application Publication
(10) Pub. No.: US 2023/0224183 A1
(43) Pub. Date: Jul. 13, 2023

(54) System and Method for Automatically Managing a Living Space

(71) Applicants: Demir Rakanovic, Sezana (SI); Zlatko Sijercic, Palm City, FL (US)

(72) Inventors: Demir Rakanovic, Sezana (SI); Zlatko Sijercic, Palm City, FL (US)

(21) Appl. No.: 17/575,519

(22) Filed: Jan. 13, 2022

(51) Int. Cl. H04L 12/28; H04L 67/12; G16Y 40/30; G16Y 20/10

(52) U.S. Cl. CPC H04L 12/2816; H04L 67/12; G16Y 40/30; G16Y 20/10; H04L 2012/2841

(57) ABSTRACT

A system and method for automatically managing a living space relates to Internet of Things (IoT) implementations within a commercial or residential location that allow for fully private management of collected data. Such a system enables users to automate many different functions within their homes and properties, including temperature management, room illumination, humidity, and more, in order to optimize for a chosen metric, such as comfort, energy efficiency, or cost efficiency. Because the user takes ownership over sensors, servers, and output devices, collected data may be parsed, organized, stored, applied, and otherwise utilized without risk of exposing collected data to external parties. This control enables users to develop various interfaces, algorithms, command signals, visuals, and more at will, thereby ensuring the user may customize a living space according to whatever desirable outcomes the user chooses. A user may add further subsystems and features at will, enabling complex and varied implementations.

### FIELD OF THE INVENTION

The present invention generally relates to private supervisory systems. More specifically, the system and method for automatically managing a living space relates to a method for automatically manipulating environmental conditions within an inhabited space, such that external parties cannot access, collect, store, sell, or otherwise interact with the privately collected data.

### BACKGROUND OF THE INVENTION

The continual development of more powerful and less expensive electronic sensors has resulted in the advent of a new class of environmentally-responsive devices. Common items in both consumer and non-consumer spaces can now provide feedback relating to their condition, age, status, and more based upon measurements automatically taken with these sensors. The interconnection of this data is generally referred to as the Internet of Things (IoT) and may be the key to unlocking the next level of automated efficiency and convenience for many products.

Unfortunately, such sensors are often interconnected in such a manner as to provide external parties access to data that should be private. Data security is a constant presence in the media, and consumers do not currently have an adequate level of control over which groups can access their data. Due to often unethical company practices, this can result in information being shared with marketers and hostile groups, enabling such parties to use various media sources to manipulate the opinions and decision-making of unsuspecting users to fit their needs. While better sensors can result in better products, these improvements often come at a high hidden cost.

Residential and commercial real estate provides an excellent example of an industry which stands to gain greatly from the use of inexpensive, high-quality sensors. Several companies have developed products which monitor room conditions and transfer electronic command signals to appropriate devices, thereby allowing for automated adjustment and improvement of conditions within that room. As an illustrative example, a light sensor array within an inhabited space may determine that a room is receiving below-optimal ambient lighting and may then relay a command to adjust dimmable bulbs within the room in response to the received and processed data, thus achieving optimal lighting automatically. These companies may use similar implementations to adjust air quality, temperature, pressure, chemical composition, room cleanliness, and many more. The unfortunate reality, however, is that these companies often also utilize this data to achieve their own means beyond the consumer-desired results, whether through selling that data against the wishes of the user or undesirably using it for marketing purposes. Furthermore, a user may not have adequate control over “optimal” conditions but may rather be subjected to default conditions that are not adequately customizable to the user's needs. What is needed is a way for a user to implement a room management system that allows for fully private control over the flow of collected data. Further desirable is a system that enables the user to develop applications and implementations utilizing sensor-collected data at the user's discretion.

The present invention addresses these issues. The system and method for automatically managing a living space relates to IoT implementations within a commercial or residential location that allow for fully private management of collected data. Such a system enables users to automate many different functions within their homes and properties, including temperature management, room illumination, humidity, and more, in order to optimize for a chosen metric, such as comfort, energy efficiency, or cost efficiency. Because the user takes ownership over sensors, servers, and output devices, collected data may be parsed, organized, stored, applied, and otherwise utilized without risk of exposing collected data to external parties. This control enables users to develop various interfaces, algorithms, command signals, visuals, and more at will, thereby ensuring the user may customize a living space according to whatever desirable outcomes the user chooses. A user may add further subsystems and features at will. Such subsystems benefit the user due to the possibility of utilizing modular improvements, as the user does not need to hire a professional in order to install smart devices for specific inputs and outputs. This also enables the user to save money on both the input/output devices and service charges, both of which are expensive when installing pre-built subsystems. Furthermore, such an arrangement allows for relatively easy and convenient removal or upgrading of outdated or otherwise undesirable subsystems. Each subsystem implemented within the present invention may use common communication channels (ethernet, wireless internet, etc.), and do not need to establish new proprietary radio networks on location, as is common with many preassembled subsystems. While the private server or servers used are not required to be on-site and may be able to be used remotely, such tools provide a high degree of security over private data regardless as data is never exposed to the Internet.

### BRIEF DESCRIPTION OF THE DRAWINGS

FIG. 1 is a schematic diagram illustrating the system of the present invention.

FIG. 2 is a flowchart illustrating the overall process of the present invention.

FIG. 3 is a continuation of FIG. 2.

FIG. 4 is a flowchart illustrating a subprocess of utilizing a tabular data arrangement.

FIG. 5 is a flowchart illustrating a subprocess of adjusting to high temperatures.

FIG. 6 is a flowchart illustrating a subprocess of collecting high temperature data with temperature sensors.

FIG. 7 is a flowchart illustrating a subprocess of adjusting to low temperatures.

FIG. 8 is a flowchart illustrating a subprocess of collecting low temperature data with temperature sensors.

FIG. 9 is a flowchart illustrating a subprocess of adjusting to high humidity.

FIG. 10 is a flowchart illustrating a subprocess of collecting high humidity data with humidity sensors.

FIG. 11 is a flowchart illustrating a subprocess of adjusting to low humidity.

FIG. 12 is a flowchart illustrating a subprocess of collecting low humidity data with humidity sensors.

FIG. 13 is a flowchart illustrating a subprocess of adjusting to lighting conditions.

FIG. 14 is a flowchart illustrating a subprocess of adjusting the power inputs of electrically-powered devices.

FIG. 15 is a flowchart illustrating a subprocess of collecting electrical power data with electricity-metering sensors.

FIG. 16 is a flowchart illustrating a subprocess of outputting general user alerts.

FIG. 17 is a flowchart illustrating a subprocess of generating intruder alerts based on unexpected motion.

FIG. 18 is a flowchart illustrating a subprocess of generating humidity alerts.

FIG. 19 is a flowchart illustrating a subprocess of generating pressure alerts.

FIG. 20 is a flowchart illustrating a subprocess of generating air-quality alerts.

### DETAILED DESCRIPTION OF THE INVENTION

All illustrations of the drawings are for the purpose of describing selected versions of the present invention and are not intended to limit the scope of the present invention.

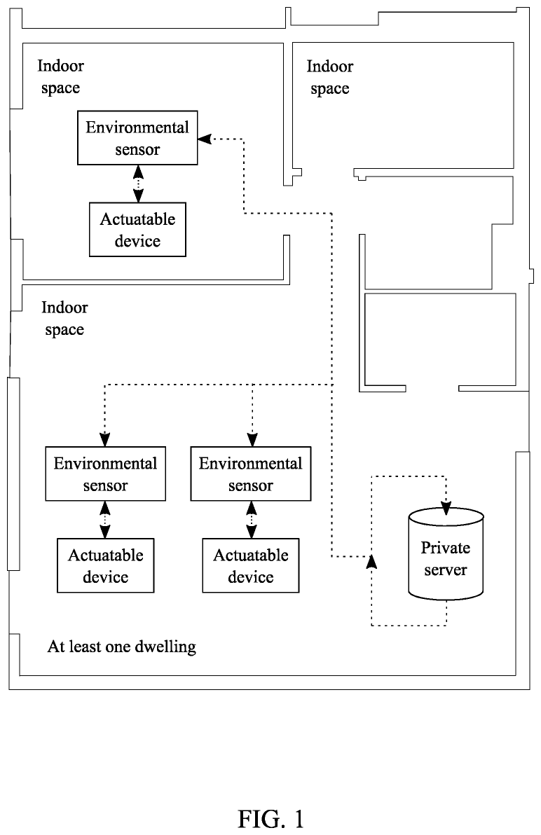

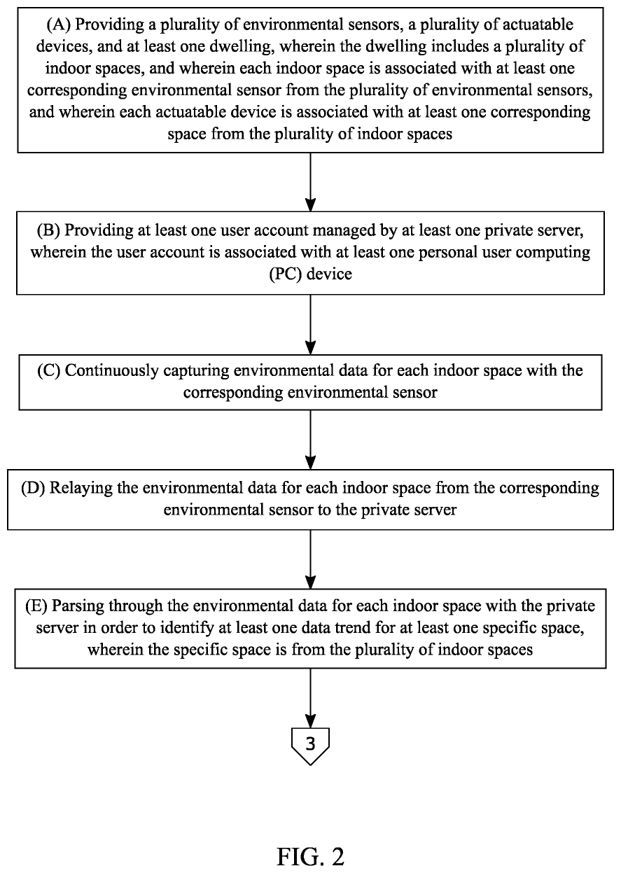

The present invention is a system and method for automatically managing a living space that provides a system for interacting with various input devices, especially via electronic sensors, as represented in FIG. 1. The present invention operates within a fully private server network, thus preventing access by external parties. The system of the present invention includes a plurality of environmental sensors, a plurality of actuatable devices, and at least one dwelling, wherein the dwelling includes a plurality of indoor spaces, and wherein each indoor space is associated with at least one corresponding environmental sensor from the plurality of environmental sensors, and wherein each actuatable device is associated with at least one corresponding space from the plurality of indoor spaces (Step A), as represented in FIG. 2. The plurality of environmental sensors is a set of electronic devices capable of detecting changes in ambient environmental conditions and generating and relaying corresponding electronic signals to appropriate devices. The plurality of actuatable devices denotes the set of switches that control various units across the dwelling, especially switches, levers, digital triggers, and more associated with air quality control devices, heating, ventilation, and air conditioning (HVAC) devices, power devices, and many more such tools capable of interacting with and controlling their environments. The dwelling is a residential, commercial, general, or other such piece of developed real estate in which people may reside. The plurality of indoor spaces is the set of rooms or spaces which a user may be interested in automatically regulating or otherwise affecting. Furthermore, at least one user account managed by at least one private server may be provided, wherein the user account is associated with at least one user personal computing (PC) device (Step B). The user account relates to an owner or primary operator of the dwelling in relation to the present invention. The user account may include, but is not limited to, a username, authentication information, contact information, and any other such information that may be useful in allowing the user to automate systems within the dwelling.

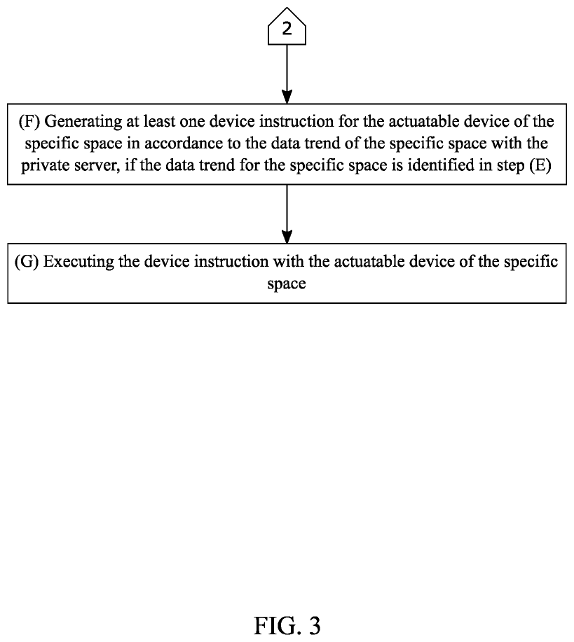

The overall process followed by the method of the present invention allows for effective and efficient management of a living space. Environmental data for each indoor space may be captured with the corresponding environmental sensor (Step C). The environmental data enables the present invention to determine appropriate signals to relay to each appropriate actuatable device. Next, the environmental data for each indoor space may be relayed from the corresponding environmental sensor to the private server (Step D). This arrangement enables raw data to enter the private server for subsequent processing. The environmental data for each indoor space may then be parsed with the private server in order to identify at least one data trend for at least one specific space, wherein the specific space is from the plurality of indoor spaces (Step E). The at least one data trend is a pattern of environmental conditions or behavior detected through analysis of the environmental data. The private server, being privately managed by the user account, is an electronic controller that accepts electronic signal inputs and allows the user full customization and control over output options. Such control may include, but is not limited to, tabularizing, cleaning, appending, removing, replacing, calculating, storing, relaying, applying machine learning algorithms, and otherwise manipulating data according to the user's programmed instructions. Subsequently, at least one device instruction may be generated for the actuatable device of the specific space in accordance to the data trend of the specific space with the private server, if the data trend for the specific space is identified in Step E (Step F), as represented in FIG. 3. The device instruction may relate to electronic commands created according to the programmed rules set by the user account that are sent to the actuatable device, such as toggling, tuning, providing data streams, and more information that allows the actuatable device to adjust appropriately. Finally, the device instruction may be executed with the actuatable device of the specific space (Step G). In this way, the present invention enables automatic operation of each of the actuatable devices within the dwelling.

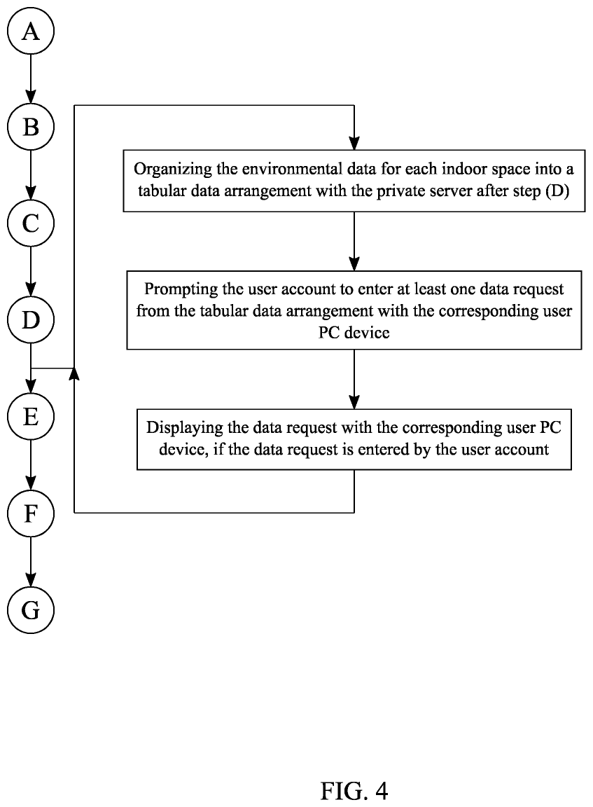

The user may wish to interact with acquired data by organizing data into tables, thereby enabling and facilitating a variety of different analyses and generation of complex instructions. To this end, the environmental data for each indoor space may be organized into a tabular data arrangement with the private server after Step D, as represented in FIG. 4. The tabular data arrangement is a data cleaning process that may result in the creation of both common and virtual spreadsheets, thereby enabling data interaction through structured query language (SQL) as well as a variety of other database interaction languages and mechanisms according to the preferences of the user account. Next, the user account may be prompted to enter at least one data request from the tabular data arrangement with the corresponding user PC device. The data request is an interaction with the tabular data arrangement that allows the user account to perform various data manipulations and control logic implementations. The data request may then be displayed with the corresponding user PC device, if the data request is entered by the user account. Thus, the user may view results of data manipulations of data within the data request, thereby enabling rapid prototyping and customizable decision-making. In an exemplary embodiment, the user account may utilize the data request to interact with data through a line interface, such as a command prompt or other such interface, thereby increasing computing efficiency and optimizing use of computer resources.

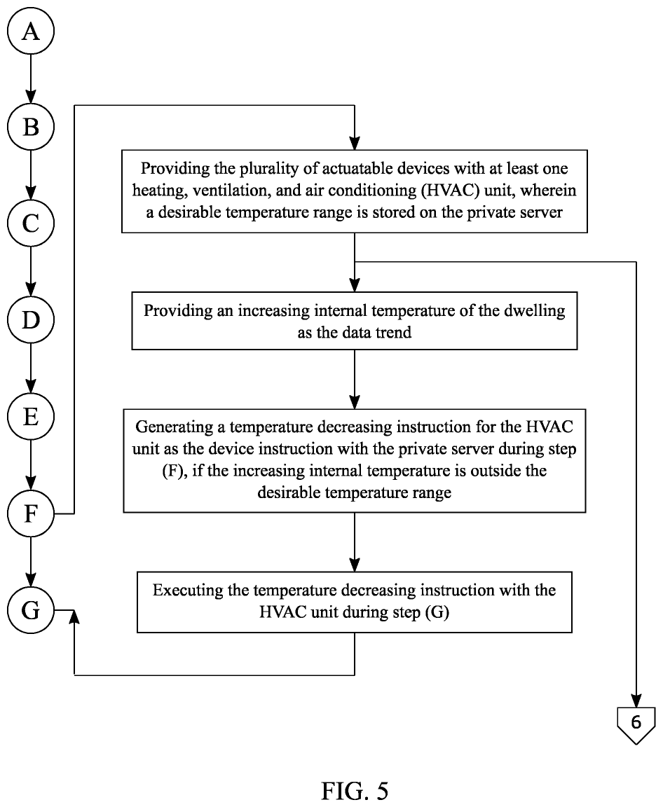

It may be desirable for a user account to wish to automatically decrease the temperature of the air within a room. To enable this, the plurality of actuatable devices may be provided with at least one heating, ventilation, and air conditioning (HVAC) unit, wherein a desirable temperature range is stored on the private server, as represented in FIG. 5. The HVAC unit relates to any device capable of sustaining and adjusting the temperature within a given indoor space from the plurality of indoor spaces. The desirable temperature range is a set of values between a predefined upper temperature limit and a predefined lower temperature limit. The desirable temperature range may be dynamically defined as a function of a variety of parameters, including the environmental data, time data, calendar data, and more, thereby enabling automatic adjustment of the desirable temperature range in response to a variety of data inputs. Furthermore, an increasing internal temperature of the dwelling may be provided as the data trend. The increasing internal temperature is a trend of values that is moving towards the upper limit of the desirable temperature range. A temperature decreasing instruction for the HVAC unit may then be generated as the device instruction with the private server during Step F, if the increasing internal temperature is outside the desirable temperature range. The temperature decreasing instruction is an electronic command to the HVAC unit to adjust temperature regulation output towards an appropriate level within the desirable temperature range, below the upper limit of the desirable temperature trend. Finally, the temperature decreasing instruction may be executed with the HVAC unit during Step G. In this way, the HVAC unit may receive desirable operating instructions without direct, physical input from the user account.

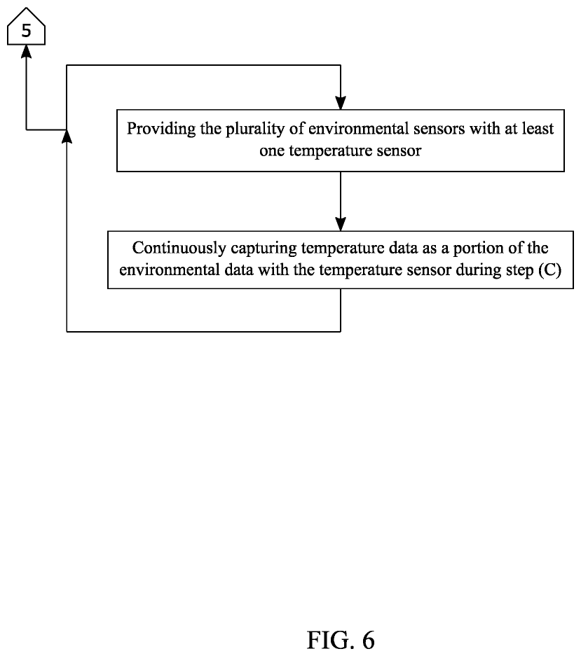

It may be further desirable for the plurality of environmental sensors to capture potentially-relevant data from within the dwelling. To enable this, the plurality of environmental sensors may be provided with at least one temperature sensor, as represented in FIG. 6. The temperature sensor is an electronic device capable of detecting changes in the ambient temperature of the indoor space. The temperature data may then be captured as a portion of the environmental data with the temperature sensor during Step C. This arrangement allows the present invention to accept temperature values directly from the source, thereby improving the potential accuracy of the temperature decreasing instruction.

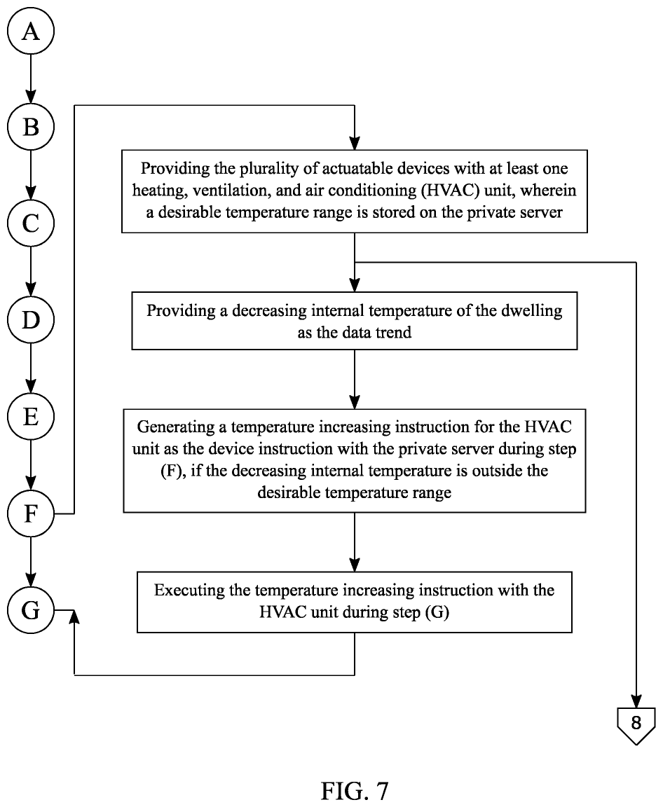

Alternatively, it is common for a user account to wish to increase the temperature of the air within a room. To facilitate automation of this, the plurality of actuatable devices may be provided with at least one HVAC unit, wherein a desirable temperature range is stored on the private server, as represented in FIG. 7. Furthermore, a decreasing internal temperature of the dwelling may be provided as the data trend. The decreasing internal temperature is a trend of values that is moving towards the lower limit of the desirable temperature range. A temperature increasing instruction for the HVAC unit may then be generated as the device instruction with the private server during Step F, if the decreasing internal temperature is outside the desirable temperature range. The temperature increasing instruction is an electronic command to the HVAC unit to adjust to an appropriate level within the desirable temperature range, above the lower limit of the desirable temperature trend. Finally, the temperature increasing instruction may be executed with the HVAC unit during Step G. In this way, the HVAC unit may receive desirable operating instructions without direct, physical input from the user account.

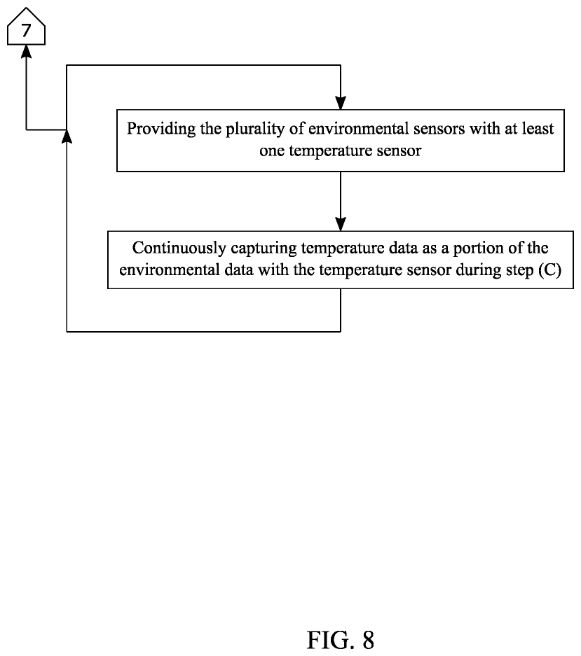

Similar to the temperature decreasing instruction, it may be desirable for the plurality of environmental sensors to capture potentially-relevant data from within the dwelling when the HVAC unit receives the temperature increasing instruction. To enable this, the plurality of environmental sensors may be provided with at least one temperature sensor, as represented in FIG. 8. The temperature data may then be captured as a portion of the environmental data with the temperature sensor during Step C. This arrangement allows the present invention to accept temperature values directly from the source, thereby improving the potential accuracy of the temperature increasing instruction.

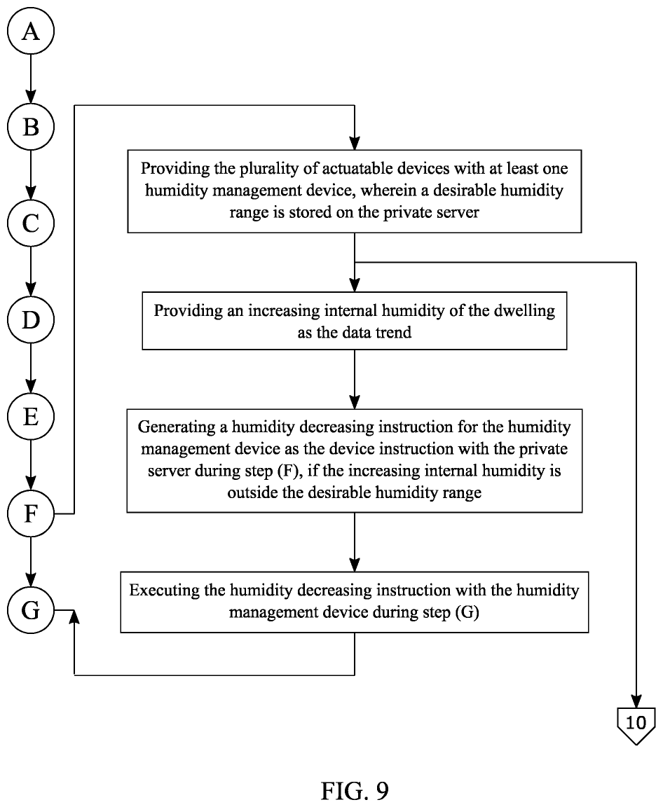

Many of the plurality of indoor spaces may benefit from the inclusion of humidity-decreasing tools. To enable an interaction with such devices, the plurality of actuatable devices may be provided with at least one humidity management device, wherein a desirable humidity range is stored on the private server, as represented in FIG. 9. The humidity management device may be a humidifier, dehumidifier, or combination of the two. The desirable humidity range is a set of values between a predefined upper humidity limit and a predefined lower humidity limit. An increasing internal humidity of the dwelling may be provided as the data trend. Thus, the humidity within the dwelling, and in some instances, in a specific indoor space, may be detected to be increasing, due to natural effects, artificial interference, or any other possible humidity-affecting inputs. A humidity decreasing instruction may then be generated for the humidity management device as the device instruction with the private server during Step F, if the increasing internal humidity is outside the desirable humidity range. The humidity decreasing instruction is an electronic command signal relayed to the humidity management device with the private server that directs the humidity management device to begin to reduce the humidity of the dwelling or the associated indoor space. The humidity decreasing instruction may then be executed with the humidity management device during Step G. Thus, the humidity management device may be utilized to lower the humidity within a room.

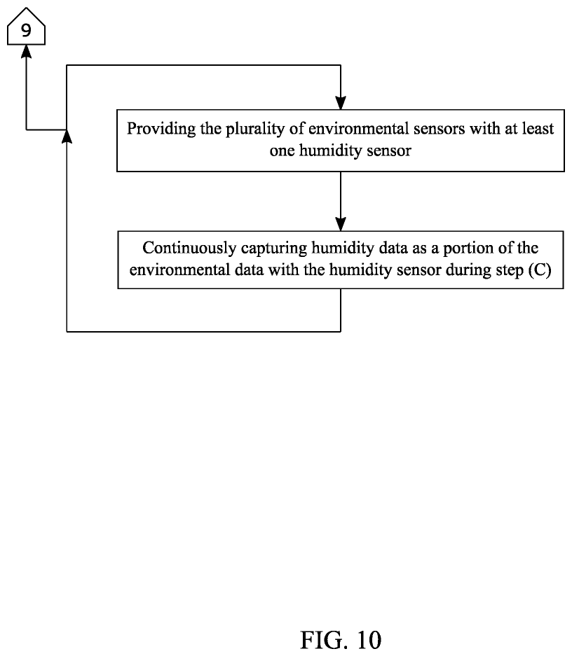

Furthermore, it may be advantageous to provide data collection tools that enhance the ability of the humidity management device and the private server to measure humidity, thereby enabling determination of successful humidity adjustments. To this end, the plurality of environmental sensors may be provided with at least one humidity sensor, as represented in FIG. 10. The humidity sensor is a device capable of measuring the humidity within a room. Humidity data may be continuously captured as a portion of the environmental data with the humidity sensor during Step C. In this way, the private server may use data collected from the humidity sensor to determine whether to continue to send the humidity decreasing instruction to the humidity management device.

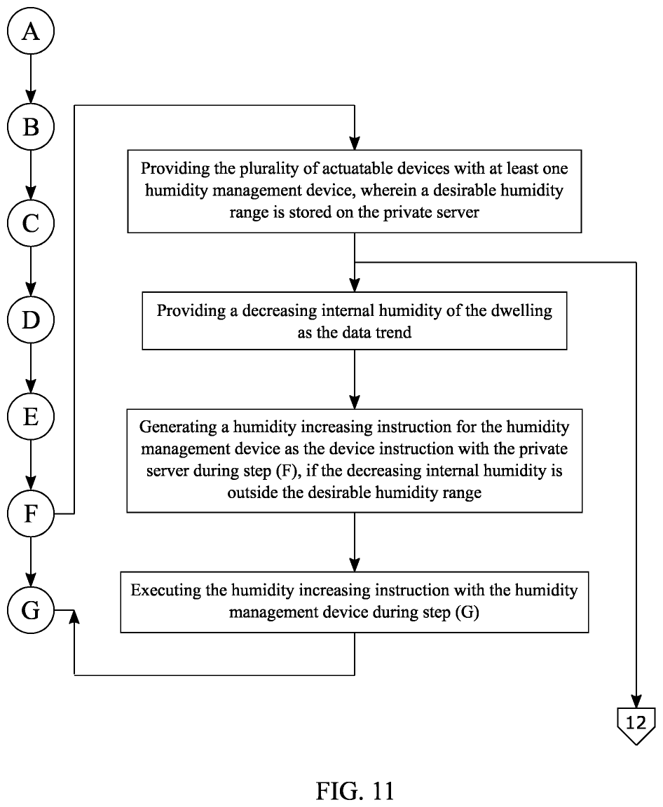

Similarly, the plurality of indoor spaces may benefit from the inclusion of humidity-increasing tools. To allow for this, the plurality of actuatable devices may be provided with at least one humidity management device, wherein a desirable humidity range is stored on the private server, as represented in FIG. 11. A decreasing internal humidity of the dwelling may also be provided as the data trend. Thus, the humidity within the dwelling, and in some instances, in a specific indoor space, may be detected to be decreasing due to either natural effects or to artificial interference. A humidity increasing instruction may then be generated for the humidity management device as the device instruction with the private server during Step F, if the decreasing internal humidity is outside the desirable humidity range. The humidity increasing instruction is an electronic command signal relayed to the humidity management device with the private server directing the humidity management device to raise the humidity of the dwelling or the associated indoor space. The humidity increasing instruction may then be executed with the humidity management device during Step G. Thus, the humidity management device may be utilized to raise the humidity within a room.

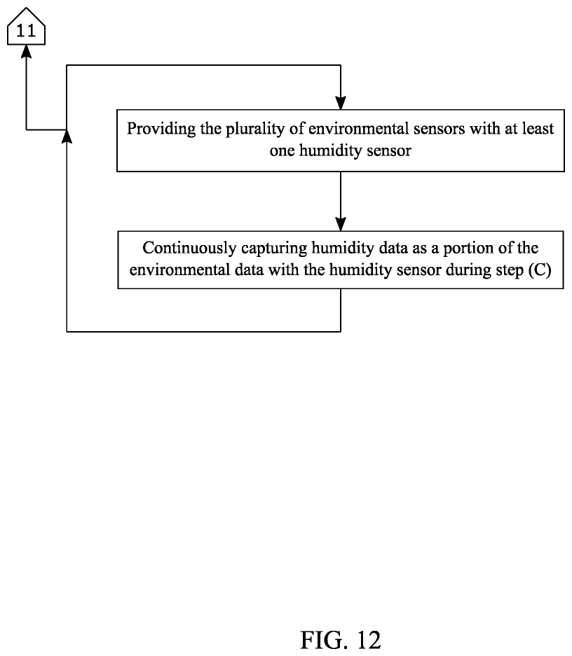

It may also be advantageous to provide data collection tools that enhance the ability of the humidity management device and the private server to measure humidity, thereby enabling determination of successful humidity adjustments. To this end, the plurality of environmental sensors may be provided with at least one humidity sensor, as represented in FIG. 12. Humidity data may be continuously captured as a portion of the environmental data with the humidity sensor during Step C. In this way, the private server may use data collected from the humidity sensor to determine whether to continue to send the humidity increasing instruction to the humidity management device.

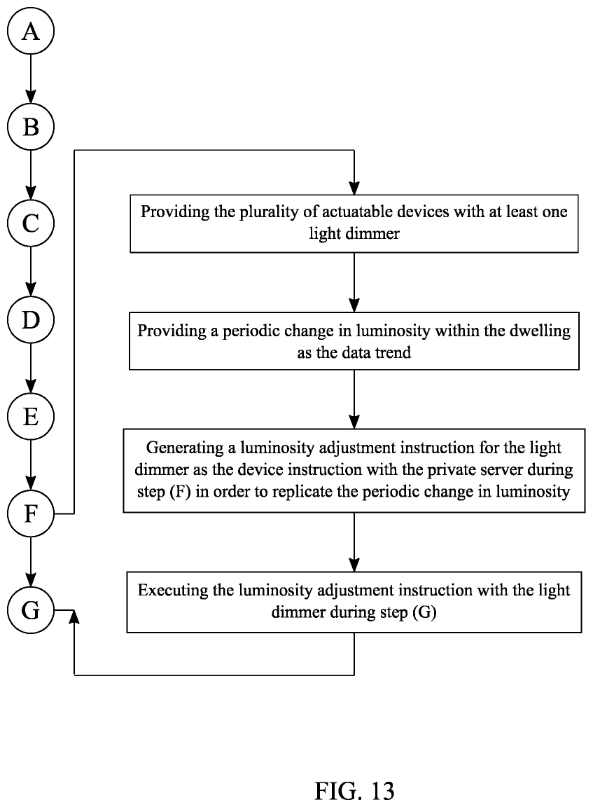

Often, a user account may wish to automatically manipulate the illumination within the dwelling or a specific indoor space. To provide for this, the plurality of actuatable devices may be provided with at least one light dimmer, as represented in FIG. 13. The light dimmer relates to a mechanism capable of adjusting the brightness of an electrically connected lightbulb or light source through a sliding scale of possible brightness values. A periodic change in luminosity may also be provided within the dwelling as the data trend. The periodic change in luminosity may relate to ambient lighting conditions, which may be affected by exposure of the indoor space to sunlight, other lighting sources, or other similar stimuli. A luminosity adjustment instruction for the light dimmer may then be generated as the device instruction with the private server during Step F in order to replicate the periodic change in luminosity. The luminosity adjustment instruction is an electronic command signal that communicates to the light dimmer actuation the amount of luminous intensity that must be adjusted and the direction in which the adjustment must be made. Finally, the luminosity adjustment instruction may be executed with the light dimmer during Step G. In this way, the light dimmer may respond to commands from the private server, thereby enabling the user account to program custom responsive control over the lighting within the dwelling.

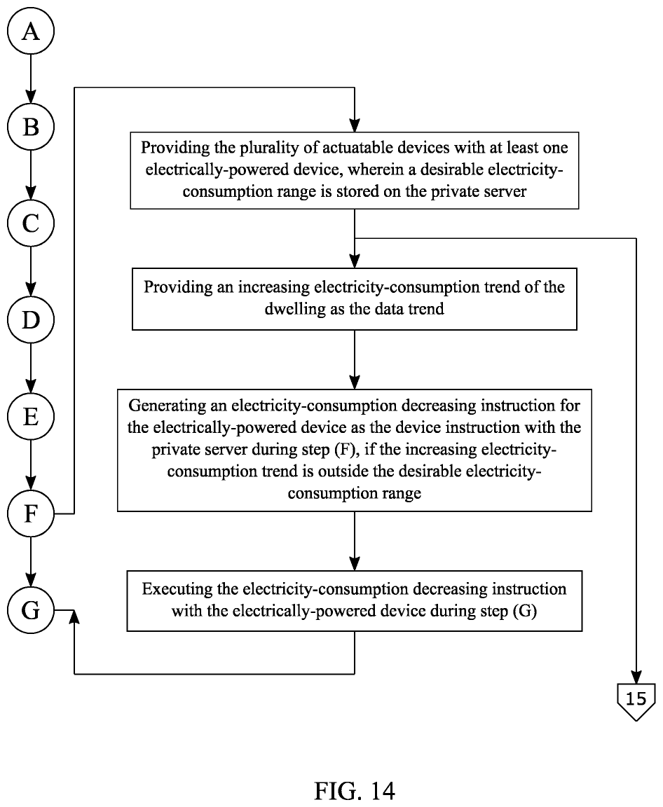

Often, devices that are plugged into an electrical outlet consume unknown amounts of energy, leading users to pay for electrical power without knowing or controlling the electrical consumption of their devices. To provide users more control over their electrical power usage, the plurality of actuatable devices may be provided with at least one electrically-powered device, wherein a desirable electricity-consumption range is stored on the private server, as represented in FIG. 14. The electrically-powered device relates to any of a variety of tools that require electrical power, especially from an electrical outlet, for operation. The desirable electricity-consumption range is a set of values of voltage, current, potential, joules, or other such units of measurement between an upper electrical limit and a lower electrical limit. An increasing electricity-consumption trend of the dwelling may be provided as the data trend. This arrangement may be determined through analysis of the environmental data and establishes the potential for necessary downward readjustment of the electrically-powered device. An electricity-consumption decreasing instruction for the electrically-powered device may then be generated as the device instruction with the private server during Step F, if the increasing electricity-consumption trend is outside the desirable electricity-consumption range. The electricity-consumption decreasing instruction is an electronic command signal that directs the electrically-powered device to reduce power consumption. In an exemplary embodiment, minimum electrical energy requirements for operation of the electrically-powered device may be taken into consideration and may be utilized to toggle the electrically-powered device on or off. The electricity-consumption decreasing instruction may then be executed with the electrically-powered device during Step G. In this way, the private server may control the power usage of each item within the dwelling.

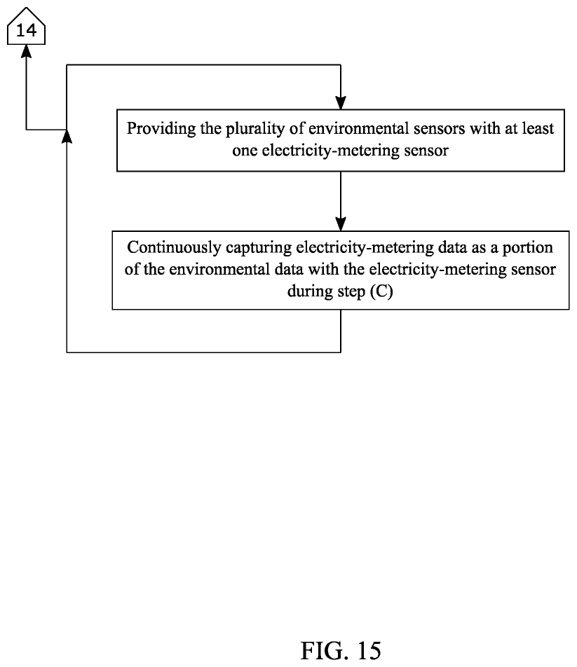

The private server may further benefit from data collection tools that enhance the ability of the private server to measure electrical power output, thereby enabling determination of successful electrical power adjustments. To this end, the plurality of environmental sensors may be provided with at least one electricity-metering sensor, as represented in FIG. 15. The electricity-metering sensor relates to an ammeter, voltmeter, ohmmeter, or other such multimeter device capable of measuring electrical power output, either directly or indirectly through subsequent calculation. Such a device may be integrated into the circuitry of the dwelling itself, between the electrically-powered device and an outlet or power source, within the electrically-powered device, or otherwise integrated so as to collect relevant power consumption data. Next, electricity-metering data may be continuously captured as a portion of the environmental data with the electricity-metering sensor during Step C. In this way, the private server may respond in real-time to the electrical power demands of the electrically-powered device.

While temperature regulation, humidity regulation, illumination control, and electricity consumption are explicitly discussed above, note that a variety of other outputs are possible. Furthermore, note that different sensors may provide informative and useful data to affect other systems. As an illustrative example, the data collected from the humidity sensor may be useful in calculating, or otherwise determining, the parameters of the desirable temperature range. These systems are designed cooperatively, so that there cannot be a system-inhibiting conflict between the luminosity adjustment instruction and an electricity-consumption decreasing instruction or an electricity-consumption increasing instruction. Such conflicts may be resolved in accordance with instructions from the user account or may be programmed to defaults before overall system failure occurs.

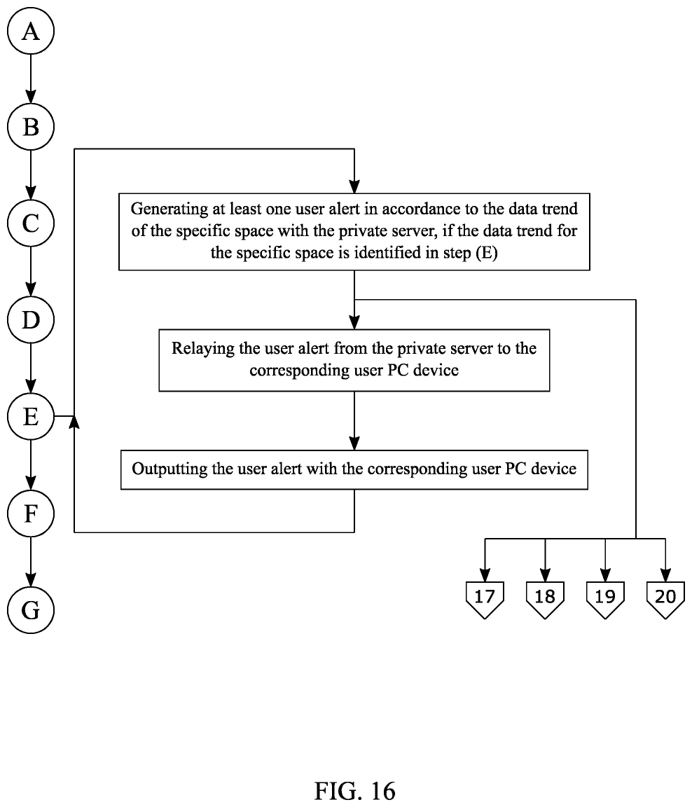

In many cases, it may be useful to allow for the automated relay of messages in response to different analyses of the environmental data by the private server. To enable this, at least one user alert may be generated in accordance to the data trend of the specific space with the private server, if the data trend for the specific space is identified in Step E, as represented in FIG. 16. The user alert relates to a notification, including textual messages, visuals, or a variety of other multimedia data, that may communicate the current analysis of the private server. This arrangement allows users to be notified of undesirable motion, temperature conditions, atmospheric conditions, and more as desired. Next, the user alert may be relayed from the private server to the corresponding user PC device. Thus, the user alert may be processed for viewing by the user PC device. Finally, the user alert may be outputted with the corresponding user PC device. This arrangement allows the user to respond to different conditions as they occur within the dwelling.

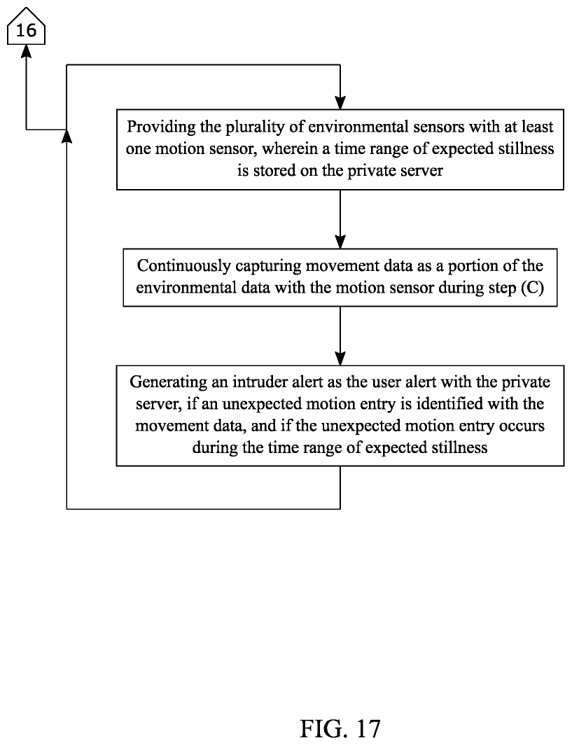

A user of the present invention may benefit from knowledge of unauthorized or unexpected motion within the dwelling. To enable this, the plurality of environmental sensors may be provided with at least one motion sensor, wherein a time range of expected stillness is stored on the private server, as represented in FIG. 17. The motion sensor is any electronic device or array of devices capable of detecting motion. The time range of expected stillness is a time duration in which there is not expected to be motion within the dwelling, such as when the user account is away from the dwelling. Movement data is next continuously captured as a portion of the environmental data with the motion sensor during Step C. The movement data may relate to proximity measurements, image comparisons, light changes, or a variety of other inputs that may detect motion. Finally, an intruder alert may be generated as the user alert with the private server, if an unexpected motion entry is identified within the movement data, and if the unexpected motion entry occurs during the time range of expected stillness. In this way, the user account may be notified of the presence of an unexpected party within the dwelling.

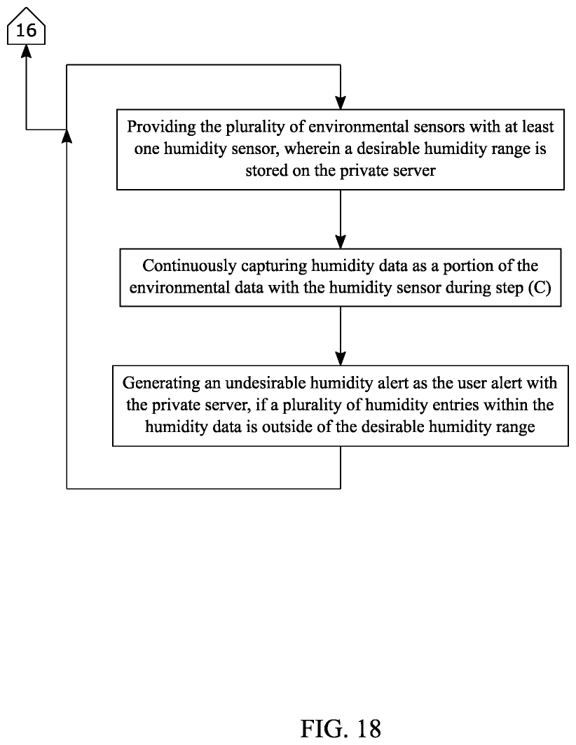

Furthermore, a user of the present invention may wish to be alerted to changes in the humidity within the dwelling. To this end, the plurality of environmental sensors may be provided with at least one humidity sensor, wherein a desirable humidity range is stored on the private server, as represented in FIG. 18. The humidity sensor is any electronic device or array of devices capable of detecting changes in the moisture content of proximal air. The desirable humidity range is a set of values between an upper moisture limit and a lower moisture limit deemed by the user account to be desirable humidity conditions. Humidity data is next continuously captured as a portion of the environmental data with the humidity sensor during Step C. The humidity data may relate to measurements of the water content of air in the dwelling. Finally, an undesirable humidity alert may be generated as the user alert with the private server, if a plurality of humidity entries within the humidity data is outside of the desirable humidity range. Thus, the user account may be notified of unexpectedly humid or dry conditions within the dwelling.

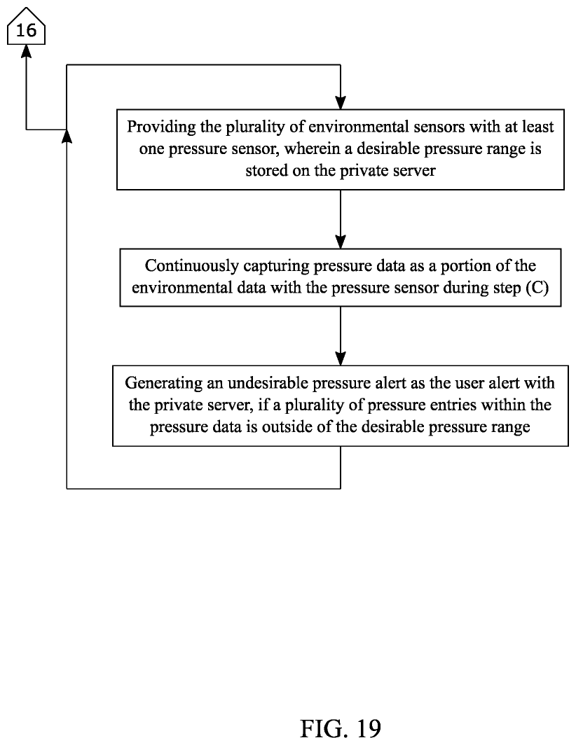

In addition, the present invention may benefit from the ability to alert the user account to changes in the pressure within the dwelling. Therefore, the plurality of environmental sensors may be provided with at least one pressure sensor, wherein a desirable pressure range is stored on the private server, as represented in FIG. 19. The pressure sensor is any electronic device or array of devices capable of detecting changes in the pressure within the dwelling or a specific indoor space. The desirable pressure range is a set of values between an upper pressure limit and a lower pressure limit deemed by the user account to be desirable pressure conditions. Pressure data is next continuously captured as a portion of the environmental data with the pressure sensor during Step C. The pressure data may be measured directly as pressure values or calculated indirectly through the capture of volume and temperature or other such conditions and subsequently derived through calculation. Finally, an undesirable pressure alert may be generated as the user alert with the private server, if a plurality of pressure entries within the pressure data is outside of the desirable pressure range. Thus, the user account may be notified of unexpected and notable pressure changes within the dwelling.

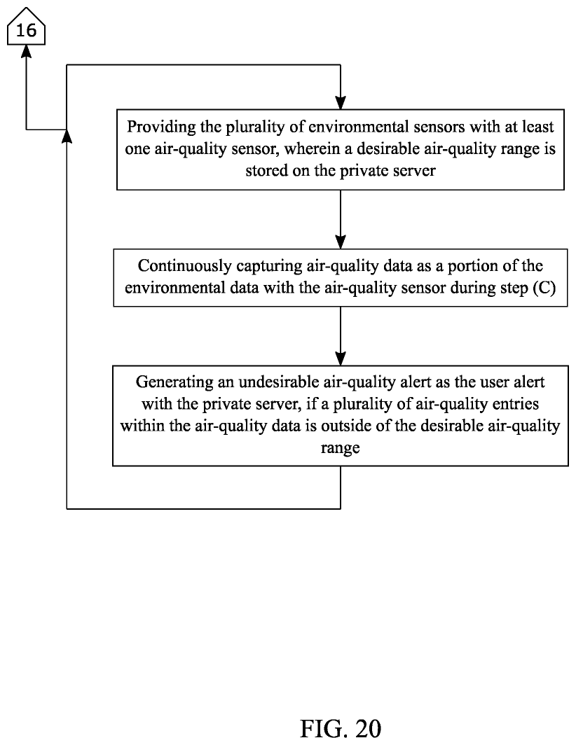

Furthermore, the user account may wish to be alerted in response to changes in air quality within the dwelling. Thus, the plurality of environmental sensors may be provided with at least one air-quality sensor, wherein a desirable air-quality range is stored on the private server, as represented in FIG. 20. The air-quality sensor is any electronic device or array of devices capable of detecting changes in the content of pollutants or impurities within the dwelling or a specific indoor space. The desirable air-quality range is a set of values between an upper air-quality limit and a lower air-quality limit deemed by the user account to be desirable air-quality conditions. Air-quality data is next continuously captured as a portion of the environmental data with the air-quality sensor during Step C. The air-quality data may be measured in relation to the content of any or any combination of potential air contaminants or may be determined based on a comparison to an ideal chemical distribution of air components. Finally, an undesirable air-quality alert may be generated as the user alert with the private server, if a plurality of air-quality entries within the air-quality data is outside of the desirable air-quality range. Thus, the user account may be notified of unexpected and notable air-quality changes within the dwelling.

Although the invention has been explained in relation to its preferred embodiment, it is to be understood that many other possible modifications and variations can be made without departing from the spirit and scope of the invention as hereinafter claimed.

What is claimed is:

1. A method for automatically managing a living space, the method comprising the steps of:
(A) providing a plurality of environmental sensors, a plurality of actuatable devices, and at least one dwelling, wherein the dwelling includes a plurality of indoor spaces, and wherein each indoor space is associated with at least one corresponding environmental sensor from the plurality of environmental sensors, and wherein each actuatable device is associated with at least one corresponding space from the plurality of indoor spaces;
(B) providing at least one user account managed by at least one private server, wherein the user account is associated with at least one user personal computing (PC) device;
(C) continuously capturing environmental data for each indoor space with the corresponding environmental sensor;
(D) relaying the environmental data for each indoor space from the corresponding environmental sensor to the private server;
(E) parsing through the environmental data for each indoor space with the private server in order to identify at least one data trend for at least one specific space, wherein the specific space is from the plurality of indoor spaces;
(F) generating at least one device instruction for the actuatable device of the specific space in accordance to the data trend of the specific space with the private server, if the data trend for the specific space is identified in step (E); and
(G) executing the device instruction with the actuatable device of the specific space.

2. The method for automatically managing a living space, the method as claimed in claim 1 comprises the steps of:
organizing the environmental data for each indoor space into a tabular data arrangement with the private server after step (D);
prompting the user account to enter at least one data request from the tabular data arrangement with the corresponding user PC device; and
displaying the data request with the corresponding user PC device, if the data request is entered by the user account.

3. The method for automatically managing a living space, the method as claimed in claim 1 comprises the steps of:
providing the plurality of actuatable devices with at least one heating, ventilation, and air conditioning (HVAC) unit, wherein a desirable temperature range is stored on the private server;
providing an increasing internal temperature of the dwelling as the data trend;
generating a temperature decreasing instruction for the HVAC unit as the device instruction with the private server during step (F), if the increasing internal temperature is outside the desirable temperature range; and
executing the temperature decreasing instruction with the HVAC unit during step (G).

4. The method for automatically managing a living space, the method as claimed in claim 3 comprises the steps of:
providing the plurality of environmental sensors with at least one temperature sensor; and
continuously capturing temperature data as a portion of the environmental data with the temperature sensor during step (C).

5. The method for automatically managing a living space, the method as claimed in claim 1 comprises the steps of:
providing the plurality of actuatable devices with at least one heating, ventilation, and air conditioning (HVAC) unit, wherein a desirable temperature range is stored on the private server;
providing a decreasing internal temperature of the dwelling as the data trend;
generating a temperature increasing instruction for the HVAC unit as the device instruction with the private server during step (F), if the decreasing internal temperature is outside the desirable temperature range; and
executing the temperature increasing instruction with the HVAC unit during step (G).

6. The method for automatically managing a living space, the method as claimed in claim 5 comprises the steps of:
providing the plurality of environmental sensors with at least one temperature sensor; and
continuously capturing temperature data as a portion of the environmental data with the temperature sensor during step (C).

7. The method for automatically managing a living space, the method as claimed in claim 1 comprises the steps of:
providing the plurality of actuatable devices with at least one humidity management device, wherein a desirable humidity range is stored on the private server;
providing an increasing internal humidity of the dwelling as the data trend;
generating a humidity decreasing instruction for the humidity management device as the device instruction with the private server during step (F), if the increasing internal humidity is outside the desirable humidity range; and
executing the humidity decreasing instruction with the humidity management device during step (G).

8. The method for automatically managing a living space, the method as claimed in claim 7 comprises the steps of:
providing the plurality of environmental sensors with at least one humidity sensor; and
continuously capturing humidity data as a portion of the environmental data with the humidity sensor during step (C).

9. The method for automatically managing a living space, the method as claimed in claim 1 comprises the steps of:
providing the plurality of actuatable devices with at least one humidity management device, wherein a desirable humidity range is stored on the private server;
providing a decreasing internal humidity of the dwelling as the data trend;
generating a humidity increasing instruction for the humidity management device as the device instruction with the private server during step (F), if the decreasing internal humidity is outside the desirable humidity range; and
executing the humidity increasing instruction with the humidity management device during step (G).

10. The method for automatically managing a living space, the method as claimed in claim 9 comprises the steps of:
providing the plurality of environmental sensors with at least one humidity sensor; and
continuously capturing humidity data as a portion of the environmental data with the humidity sensor during step (C).

11. The method for automatically managing a living space, the method as claimed in claim 1 comprises the steps of:
providing the plurality of actuatable devices with at least one light dimmer;
providing a periodic change in luminosity within the dwelling as the data trend;
generating a luminosity adjustment instruction for the light dimmer as the device instruction with the private server during step (F) in order to replicate the periodic change in luminosity; and
executing the luminosity adjustment instruction with the light dimmer during step (G).

12. The method for automatically managing a living space, the method as claimed in claim 1 comprises the steps of:
providing the plurality of actuatable devices with at least one electrically-powered device, wherein a desirable electricity-consumption range is stored on the private server;
providing an increasing electricity-consumption trend of the dwelling as the data trend;
generating an electricity-consumption decreasing instruction for the electrically-powered device as the device instruction with the private server during step (F), if the increasing electricity-consumption trend is outside the desirable electricity-consumption range; and
executing the electricity-consumption decreasing instruction with the electrically-powered device during step (G).

13. The method for automatically managing a living space, the method as claimed in claim 12 comprises the steps of:
providing the plurality of environmental sensors with at least one electricity-metering sensor; and
continuously capturing electricity-metering data as a portion of the environmental data with the electricity-metering sensor during step (C).

14. The method for automatically managing a living space, the method as claimed in claim 1 comprises the steps of:
generating at least one user alert in accordance to the data trend of the specific space with the private server, if the data trend for the specific space is identified in step (E);
relaying the user alert from the private server to the corresponding user PC device; and
outputting the user alert with the corresponding user PC device.

15. The method for automatically managing a living space, the method as claimed in claim 14 comprises the steps of:
providing the plurality of environmental sensors with at least one motion sensor, wherein a time range of expected stillness is stored on the private server;
continuously capturing movement data as a portion of the environmental data with the motion sensor during step (C); and
generating an intruder alert as the user alert with the private server, if an unexpected motion entry is identified within the movement data, and if the unexpected motion entry occurs during the time range of expected stillness.

16. The method for automatically managing a living space, the method as claimed in claim 14 comprises the steps of:
providing the plurality of environmental sensors with at least one humidity sensor, wherein a desirable humidity range is stored on the private server;
continuously capturing humidity data as a portion of the environmental data with the humidity sensor during step (C); and
generating an undesirable humidity alert as the user alert with the private server, if a plurality of humidity entries within the humidity data is outside of the desirable humidity range.

17. The method for automatically managing a living space, the method as claimed in claim 14 comprises the steps of:
providing the plurality of environmental sensors with at least one pressure sensor, wherein a desirable pressure range is stored on the private server;
continuously capturing pressure data as a portion of the environmental data with the pressure sensor during step (C); and
generating an undesirable pressure alert as the user alert with the private server, if a plurality of pressure entries within the pressure data is outside of the desirable pressure range.

18. The method for automatically managing a living space, the method as claimed in claim 14 comprises the steps of:
providing the plurality of environmental sensors with at least one air-quality sensor, wherein a desirable air-quality range is stored on the private server;
continuously capturing air-quality data as a portion of the environmental data with the air-quality sensor during step (C); and
generating an undesirable air-quality alert as the user alert with the private server, if a plurality of air-quality entries within the air-quality data is outside of the desirable air-quality range.
